(19) United States
(12) Patent Application Publication
(10) Pub. No.: US 2025/0384402 A1
(43) Pub. Date: Dec. 18, 2025

(54) SECURE PLATFORM AND METHOD FOR FACILITATING PRIVATE INVESTIGATOR SUBCONTRACTING WITH ROLE-BASED ACCESS CONTROL

(71) Applicant: Ana-Maria Ionita, Hollywood, FL (US)

(72) Inventor: Ana-Maria Ionita, Hollywood, FL (US)

(21) Appl. No.: 19/234,750

(22) Filed: Jun. 11, 2025

Related U.S. Application Data
(60) Provisional application No. 63/660,322, filed on Jun. 14, 2024.

(51) Int. Cl. G06Q 10/1053; H04L 9/40

(52) U.S. Cl. CPC G06Q 10/1053; H04L 63/105

(57) ABSTRACT

A method and system for facilitating subcontracting of investigation jobs is disclosed. In one embodiment, the method includes providing a web-based platform with a plurality of differentiated access levels for at least three user roles including private investigator agencies, hiring-only agencies, and employees. The method also includes authenticating users through an application process. The method further includes, upon successful authentication and login, presenting a workflow interface configured to authenticated user's role, wherein the workflow interface includes access to features, tools, and communications specific to the authenticated user role. The method includes allowing the private investigator agencies to access a referral posting module that is configured to: create direct referrals for specific cases by a referring investigator; enable provision of client contact information to selected direct referrals upon acceptance; allow direct referrals to optionally provide a tip to referring investigator upon case acceptance; and allow referring investigator to send tipping reminders.

### CROSS-REFERENCE TO RELATED APPLICATIONS

This application claims the benefit of U.S. Provisional Patent Application No. 63/660,322 filed on Jun. 14, 2024, the entire disclosure of which is incorporated herein by reference.

### FIELD OF THE INVENTION

The present invention relates generally to secure digital platforms for professional service, and more particularly to systems and methods for facilitating secure subcontracting between private investigators, hiring entities, and employees through role-based access control.

### BACKGROUND OF THE INVENTION

Private investigation agencies frequently need to subcontract work to other investigators for various reasons including geographical constraints, specialized expertise requirements, or workload management. However, the existing methods for managing such subcontracting relationships suffer from numerous drawbacks. Traditional subcontracting between private investigators typically relies on fragmented communication channels including emails, phone calls, and in-person meetings, thus leading to inefficiency, lack of standardization, and difficulty in maintaining comprehensive records. Prior art systems lack appropriates systems for verifying the credentials, licensing, and professional standing of private investigators before engaging them as subcontractors, thus potentially exposing hiring entities to liability and compliance issues.

Further, existing methods fail to provide adequate security for sensitive case information, client data, and investigative materials when shared between multiple parties during the subcontracting process. Without secure payment systems specific to investigative services, payment disputes arise, which may lead to financial uncertainty for subcontractors and strained professional relationships. In some instances, prior art systems lack centralized, secure document management capabilities specifically for the requirements of private investigation work, including service agreements, and case-specific materials.

Existing platforms fail to provide differentiated access based on user roles (investigators, hiring entities, employees), thereby resulting in either overly restricted access that hampers collaboration or excessive access that compromises security. Also, generic project management or freelancing platforms are not configured to the specific workflow requirements of private investigation subcontracting, such that it tend to miss critical steps such as investigator licensing verification and case-specific security protocols. Some prior art systems typically lack structured dispute resolution processes specific to investigative service contracts. The absence of standardized, customizable service agreement templates specific to private investigation subcontracting leads to inconsistent contracts with potential legal vulnerabilities. Existing methods provide limited visibility into the status of investigations, work completion, and payment processing, creating uncertainty for all parties involved.

Therefore, there is a need for a secure platform configured to address the requirements of private investigation subcontracting while providing appropriate security, verification, and workflow management capabilities.

### BRIEF SUMMARY OF THE INVENTION

It is an objective of the present invention to provide a secure platform for subcontracting between private investigators and hiring entities via a structured workflow with role-based access control.

It is another objective of the present invention to implement a user authentication system that verifies the professional credentials and licensing of private investigators before granting platform access, thus mitigating the risk of engaging unqualified or improperly licensed subcontractors.

It is yet another objective of the present invention to establish a secure payment system for private investigation subcontracting that protects both hiring entities and subcontractors from payment disputes and ensures fair compensation for completed work.

It is a further objective of the present invention to provide a document management system that enables secure creation, execution, and storage of service agreements, W9 forms, and case-specific documentation within a confidential environment that respects the sensitive nature of investigative work.

It is still another objective of the present invention to implement a differentiated access control system with at least three distinct user roles (private investigator agencies, hiring entities, and employees), each with specifically configured permissions and capabilities that maintain security while enabling efficient workflow.

It is an additional objective of the present invention to provide service agreement templates for private investigation subcontracting, thereby ensuring legal compliance and reducing potential contractual vulnerabilities.

It is yet a further objective of the present invention to establish a structured dispute resolution mechanism that provides clear protocols for addressing disagreements related to work quality, payment, or other contractual matters specific to private investigation services.

It is another objective of the present invention to implement a job management system that enables the posting, discovery, application, and tracking of private investigation assignments throughout their entire lifecycle.

It is still a further objective of the present invention to provide secure messaging capabilities that enable confidential communication between all relevant parties while maintaining a complete audit trail of all case-related discussions.

It is an objective of the present invention to establish a mutual rating system that enables both hiring entities and subcontractors to build professional reputations within the platform, thereby increasing trust and accountability in the private investigation community.

According to an exemplary embodiment of the present invention, a method for facilitating subcontracting of investigation jobs is disclosed. The method includes providing a web-based platform with a plurality of differentiated access levels for at least three user roles including private investigator agencies, hiring-only agencies, and employees. The method also includes authenticating users through an application process. The method further includes, upon successful authentication and login, presenting a workflow interface configured to the authenticated user's role, wherein the workflow interface includes access to features, tools, and communications specific to the authenticated user role. The method includes allowing the private investigator agencies to access a referral posting module that is configured to: create one or more non-subcontracted direct referrals for specific cases by a referring investigator of the private investigator agency; enable provision of client contact information to selected direct referrals upon acceptance; allow direct referrals to optionally provide a tip to the referring investigator upon case acceptance; and allow the referring investigator to send tipping reminders through an in-platform interface.

According to another embodiment of the present invention, a web-based platform for facilitating subcontracting of investigation jobs is disclosed. The platform includes a plurality of differentiated access levels configured for at least three user roles, including private investigator agencies, hiring-only agencies, and employees. The platform also includes an authentication module configured to verify users through an application process requiring proof of identity and applicable licensing. The platform further includes a workflow interface generator configured to present, upon successful authentication and login, a role-specific workflow interface comprising features, tools, and communications configured to the authenticated user's role. The platform includes a referral posting module accessible to private investigator agencies, wherein the referral posting module is configured to: allow a referring investigator of the private investigator agency to create one or more non-subcontracted direct referrals for specific cases; enable provision of client contact information to selected direct referrals upon acceptance; allow direct referrals to optionally provide a tip to the referring investigator upon case acceptance; and allow the referring investigator to send tipping reminders through an in-platform interface.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a high-level architecture of a system comprising a web-based platform that operates as a Software-as-a-Service (SaaS) solution.

FIG. 2 is a flowchart illustrating a method for facilitating subcontracting of investigation jobs via the web-based platform of FIG. 1.

FIG. 3 is a screenshot of homepage of the web-based platform depicting the features thereof.

FIG. 4 is a user dashboard of a private investigator agency, displaying job activity and progress.

FIG. 5 is a job discovery interface of the web-based platform.

FIG. 6 is a user interface of the web-based platform for initiating service agreement.

FIG. 7 is a subcontract service agreement generation interface of the web-based platform.

FIG. 8 is a screenshot of a sample case information sheet for a surveillance case.

FIG. 9 is a screenshot of a user interface for assigning the case to an employee.

FIG. 10 is a screenshot of a user interface for filing a dispute.

FIG. 11 is a user dashboard of a hiring-only agency.

FIG. 12 is an email invitation sent to an individual by an employer through the web-based platform.

FIGS. 13 and 14 are user interfaces related to referrals.

FIG. 15 depicts a direct referral posting interface of the web-based platform.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

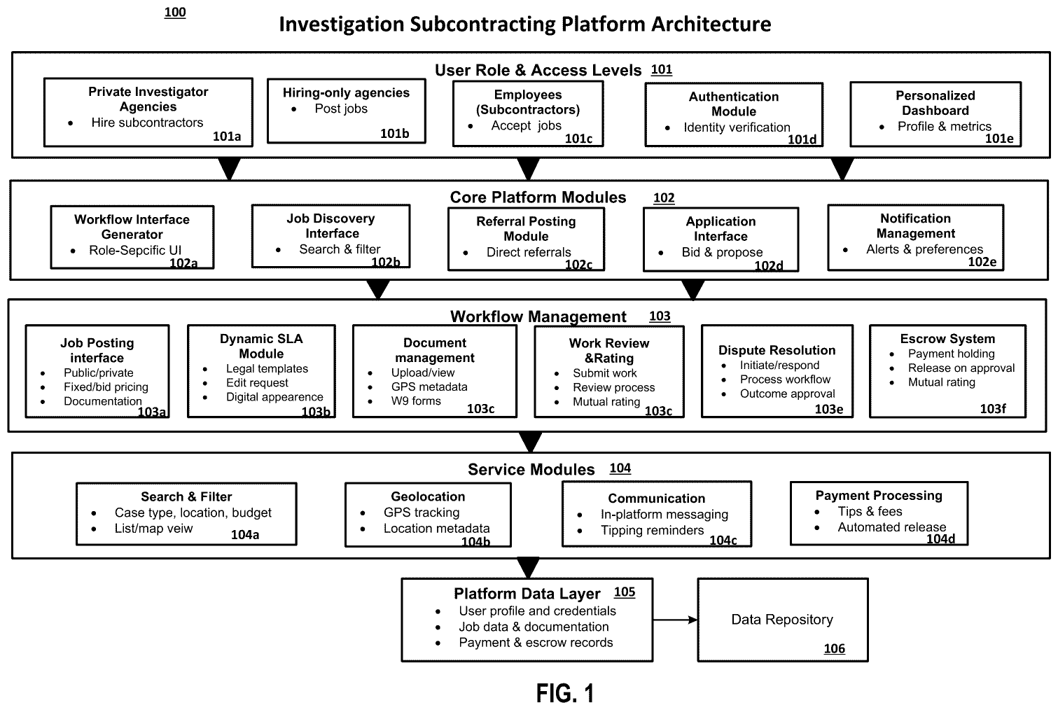

The present invention disclosed herein is a system comprising a web-based platform that operates as a Software-as-a-Service (SaaS) solution accessible through standard web browsers and mobile applications, with its architecture organized into four operational layers as illustrated in the system block diagram FIG. 1. The top layer encompasses user roles and access levels 101, providing differentiated access for private investigator agencies 101a, hiring-only agencies 101b, and employees 101c, along with an authentication module 101d and personalized dashboard 101e. The second layer contains a plurality of core platform modules 102 including a workflow interface generator 102a, a job discovery interface 102b, a referral posting module 102c, an application interface 102d, and a notification management system 102e. The third layer focuses on workflow management 103, incorporating a job posting interface 103a, a dynamic service agreement module 103b, document management system 103c, a work review and rating system 103d, a dispute resolution processes 103e, and an Escrow payment system 103f. The bottom layer provides service modules 104 including search and filter module 104a, Geolocation service module 104b, one or more communication tools 104c, and a payment processing module 104d. In various embodiments, the interfaces disclosed throughout this disclosure refer to graphical user interfaces (GUIs) of the web-based platform.

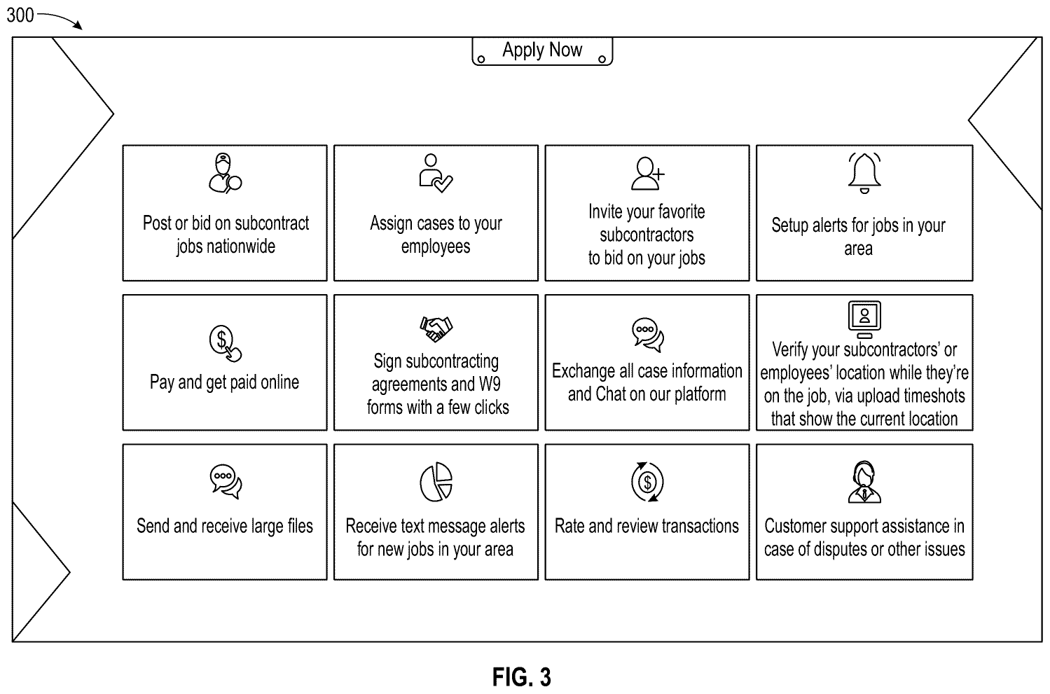

Referring FIG. 3, an overview 300 of a web-based subcontracting platform configured for private investigation professionals is depicted. The figure highlights key functionalities including the ability to post or bid on jobs, assign cases to employees, invite preferred subcontractors, and set up job alerts. Users can pay or get paid online, sign subcontracting agreements and W9 forms with ease, and exchange case information through an integrated chat system. The platform also provides tools to verify subcontractor or employee locations via uploaded timeshots, send and receive large files, receive text alerts for new jobs, rate and review transactions, and access customer support for disputes or other issues.

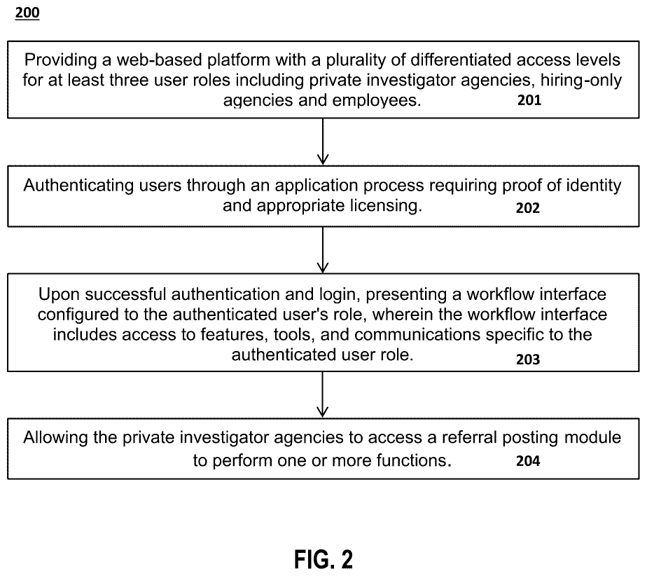

In a preferred embodiment, the layered architecture shown in FIG. 2 depicts that the data flow from user interactions through various system layers to a centralized platform data layer 105 that stores a plurality of user profiles, job data, and payment records. As depicted in the user roles and access levels layer, the authentication module implements a verification system that serves as the gateway for all user types. The authentication module processes identity verification and licensing validation for hiring entities, and employee users before granting access to role-specific platform features. In some embodiments, new users are required to complete a multi-stage application process that begins with identity verification through government-issued identification documents. The terms private investigator agency, hiring-only agency, employer, or any other equivalent terms may be used interchangeably throughout this document to refer to the hiring entities. Such terms are intended to encompass any person, entity, or organization that engages or employs personnel for investigative or related services. The term hiring-only agency may include, but is not limited to, attorneys, lawyers, insurance companies, or any other person or organization that engages personnel for investigative or related services.

For example, in one embodiment, for private investigator agencies, the system implements licensing validation procedures that cross-reference provided licensing information with one or more state and local licensing databases. Where automated API integrations are available with licensing authorities, the system performs real-time validation. For jurisdictions without digital database access, the system initiates manual verification processes that may include direct contact with licensing authorities.

Upon successful completion of the authentication process, users are assigned role-specific permissions that determine their access to platform modules, data visibility levels, and operational capabilities. The personalized dashboard presents each authenticated user with a customized interface displaying their user profile section including licensing and credential details, a job overview section listing active, past, and pending job engagements, and a summary section aggregating activity metrics such as number of completed jobs, average rating, open disputes, and earnings. In some embodiments, the system maintains detailed user profiles that include verification status, licensing information, professional credentials, performance metrics, and historical activity records.

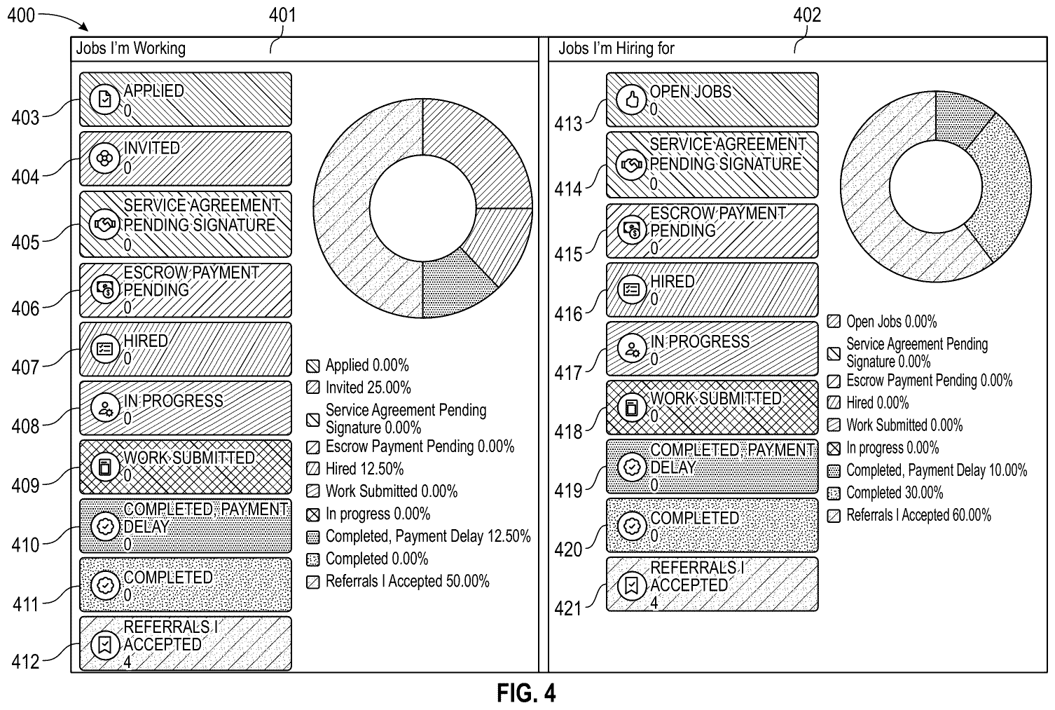

Referring FIG. 4, a user dashboard 400 of a private investigator agency is illustrated displaying job activity and progress. The dashboard 400 is split into two main sections: “Jobs I'm Working” 401 and “Jobs I'm Hiring for” 402. In one example, each section includes a status breakdown with corresponding donut charts. The left section tracks jobs where the user is a subcontractor, showing stages including applied 403, invited 404, service agreement pending signature 405, payment pending 406, hired 407, in-progress 408, work submitted 409, completed but payment delay 410, completed 411, and referrals I accepted 412, with visual and numerical indicators reflecting the percentage distribution of each stage. The right section shows jobs the user has posted as a hirer, indicating statuses such as open jobs 413, service agreement pending signature 414, payment pending 415, hired 416, in progress 417, work submitted 418, completed but payment delay 419, completed 420 and referrals I posted 421.

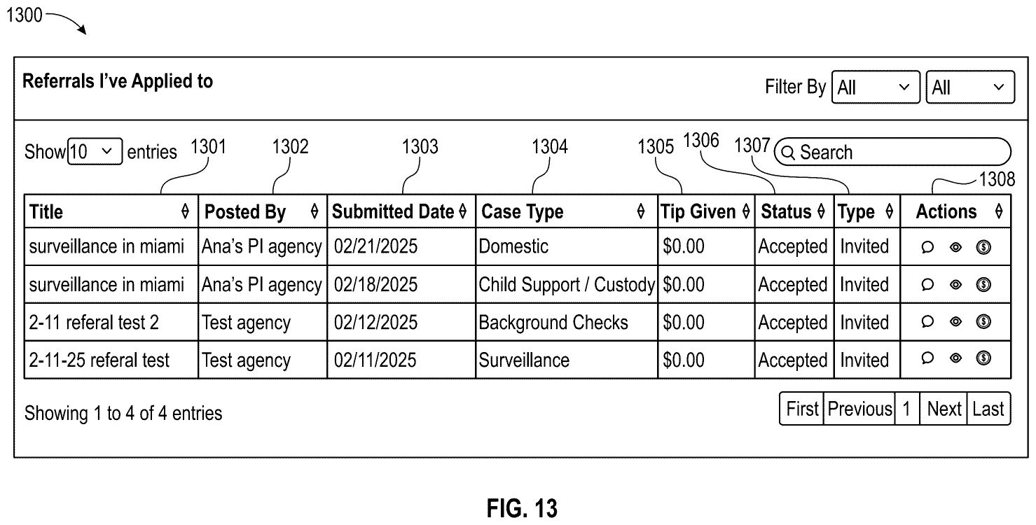

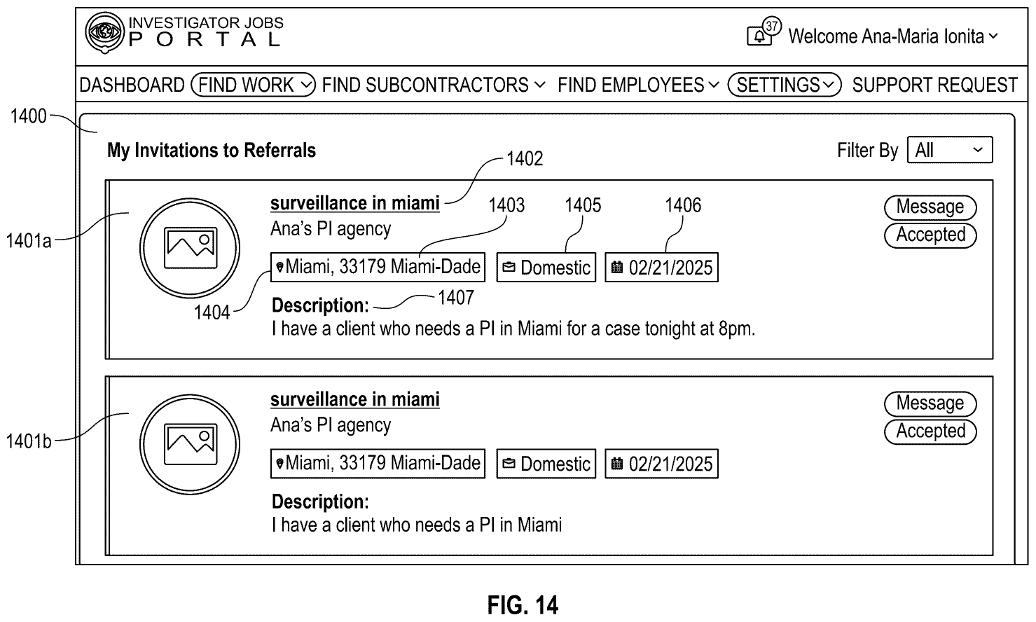

FIGS. 13 and 14 illustrate user interfaces related to referrals in the investigator agencies account. FIG. 13 shows a tabular interface 1300 listing all referral invitations accepted by a user under the section “Referrals I've Applied to.” Each referral is displayed with metadata such as the job title 1301 posting agency 1302, submission date 1303, case type 1304 (e.g., Domestic, Child Support/Custody, Background Checks), tip amount given 1305, current status 1306, and referral type 1307. In an exemplary aspect, the interactive action 1308 icons allow the user to view referral details or communicate with the posting agency.

Whereas, FIG. 14 displays an interface 1400 for “My Invitations to Referrals” for a logged-in user, providing a detailed view of referral invitations 1401a, 1401b extended to the user. Each referral card includes the referral title 1402, posting agency 1403, location 1404, case type 1405, date 1406, and a brief case description 1407 entered by the agency. In one aspect, the interface also includes direct interaction buttons—such as “Message” and status indicators (e.g., “Accepted”)—to facilitate communication and response tracking.

In both interfaces, the platform enforces any visibility restrictions configured by the posting entity, which implies that the users who are explicitly blocked by the referral poster cannot see the above mentioned listings.

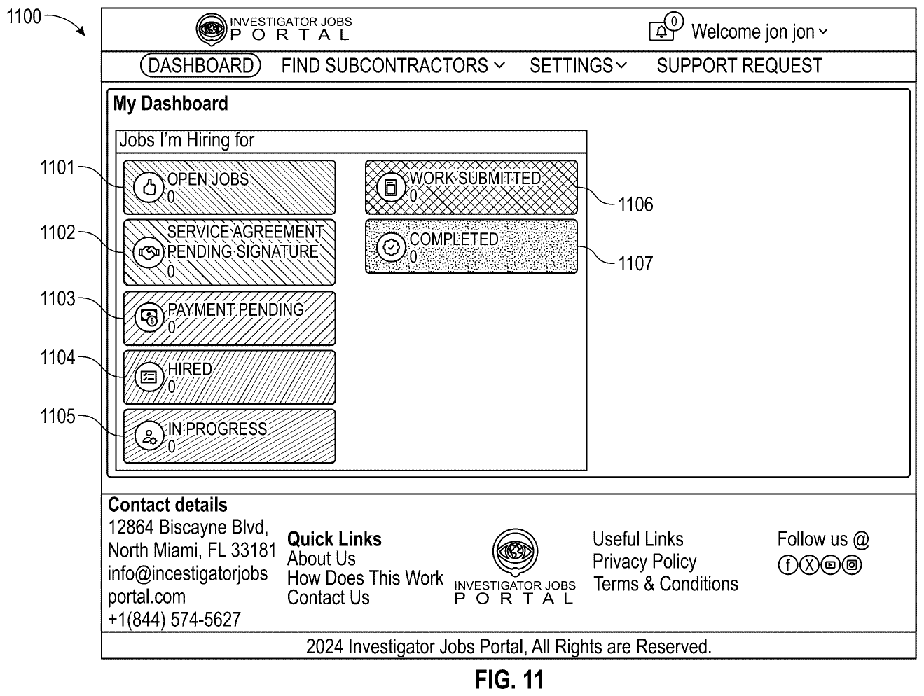

Referring FIG. 11, a user dashboard 1100 of hiring-only agencies is illustrated displaying job activity and progress. Upon logging in, details of hiring-only agencies such as lawyers, insurance companies, and similar entities are presented with the dashboard 1100. This dashboard provides an organized overview of all jobs they have posted, categorized by status: open jobs 1101, service agreement pending signature 1102, payment pending 1103, hired 1104, in progress 1105, work submitted 1106, and completed 1107. The entities can monitor the progress of their posted jobs and initiate new job postings directly from this interface. However, they are restricted from viewing jobs posted by other companies for confidentiality and a focused user experience configured to their own recruitment activities.

In an exemplary embodiment, the workflow interface generator 102a represents a system component that dynamically creates workflow user interfaces based on the authenticated user's role, current context, and historical usage patterns. Rather than presenting static interfaces, the system adapts to user behavior and presents role-specific workflow interfaces comprising features, tools, and communications configured to the authenticated user's role. The workflow interface works in conjunction with other core platform modules 107 including the job discovery interface 102b, referral posting module 102c, application interface 102d, and notification management system 102e to provide a seamless user experience configured to each user type's operational requirements. In one aspect, the platform data layer 105 consolidates user profiles and credentials, job data and documentation, and payment and escrow records into a data repository 106.

The dispute resolution system 103e within the workflow management layer 103 provides structured processes for handling conflicts that may arise during or upon completion of investigation jobs. The system 100 enables both hiring entities and subcontractors to initiate dispute resolution processes through a user interface 1000, shown in FIG. 11, that capture relevant information, supporting documentation, and desired outcomes. In one aspect, the dispute resolution system 103e integrates with the Escrow system 103f to ensure payments remain secure during dispute proceedings and are released or withheld based on resolution outcomes.

In one embodiment, the work review and rating module 103c in the workflow management layer 103 implements quality assurance mechanisms including mutual rating systems that allow both hiring entities and subcontractors to evaluate each other's performance upon job completion.

The communication tools module 104c within the service layer provides integrated messaging capabilities between all platform users, including automated reminder systems and notification management. The notification management module 102e in the core platform modules 102 enables users to configure notification preferences for receiving job-related alerts via email, SMS, or in-platform notifications, and to select specific types of jobs or updates for which alerts should be generated, including invitations, deadlines, approvals, and disputes.

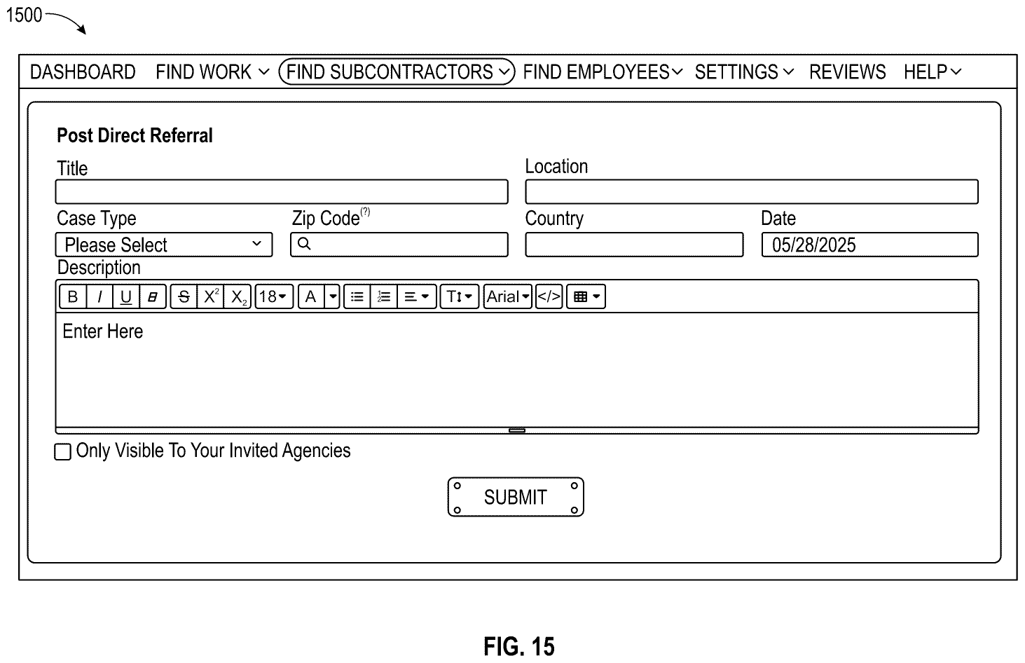

In an exemplary embodiment, the referral posting module 102c facilitates direct referral creation by private investigator agencies, enabling provision of client contact information to selected referrals upon acceptance, optional tip provision to referring investigators, and automated tipping reminders through the in-platform interface. FIG. 15 shows a direct referral posting interface 1500 of the web-based platform. The module 1500 further enables the job or referral poster to designate one or more specific members to be blocked from viewing the corresponding posting, and allowing the job or referral poster to prevent access by individuals with whom they prefer not to work again. The Escrow system 103f provides secure payment handling throughout the investigation process. When hiring entities submit payments corresponding to jobs, funds are held in platform-maintained escrow accounts until work completion and approval. The payment processing module 104d handles tips, fees, and automated payment release, via the Escrow system 103f, upon successful job completion or dispute resolution.

In certain embodiment, the escrow system 103f integrates with the dispute resolution module 103e to manage payment withholding and release based on dispute outcomes. The platform supports multiple payment models including fixed budget and open-bid formats, with automatic calculation of platform fees, contractor payments, and optional tip distributions.

The document management module 103c provides handling of investigation-related documentation with security features. Uploaded job-related documents are viewable by hiring agencies through a centralized interface and are automatically associated with geolocation metadata identifying the GPS location of upload when subcontractors have opted into location monitoring. The Geolocation services module supports GPS location identification by providing GPS tracking capabilities and location-based metadata capture for enhanced case documentation and verification purposes.

In certain embodiments, the system 100 implements role-based access controls that restrict document visibility based on user permissions and job assignments, and audit trails that track all document access, modifications, and sharing activities. For hiring-only agencies, the job posting interface 102b allows configuration of jobs as either private invitations visible only to selected subcontractors or public listings available to all platform users. The interface supports both fixed budget and open-bid pricing models. The dynamic service agreement module 103b includes industry-specific legal templates configured for private investigation services, allows subcontractors to initiate edit requests through in-platform messaging, and enables hiring entities to modify contracts based on feedback before resending for digital acceptance.

In some embodiments, the employee users, functioning as subcontractors, interact with the application interface 102d to propose start and end dates for cases, state proposed payment amounts and travel fees, attach work samples as part of applications, and review default contract terms with the ability to agree or request modifications. According to various embodiments, the employee workflow includes accepting job invitations, viewing assigned jobs, accessing job information and documents, submitting completed work, participating in dispute resolution when necessary, receiving payments, and rating employers upon job completion.

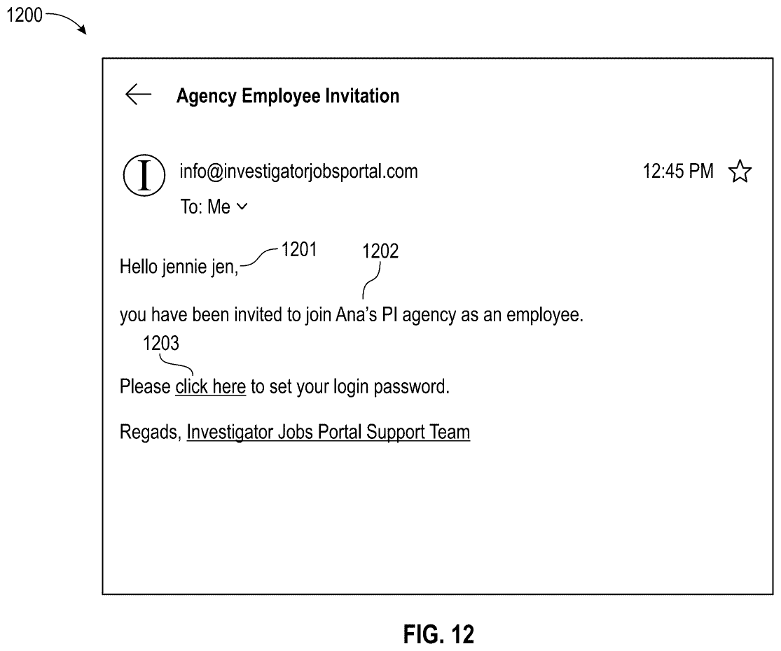

As an example, FIG. 12 illustrates an email invitation 1200 sent to an individual by an employer through the web-based platform. In depicted example, the email 1200 confirms that employee (jennie jen) 1201 has been invited to join employer (Ana's PI agency) 1203 as an employee. The recipient 1201 is instructed to click on the provided link 1203 to set their login password and complete their account setup. This process enables onboarding of employees into a private investigation agency's team on the platform.

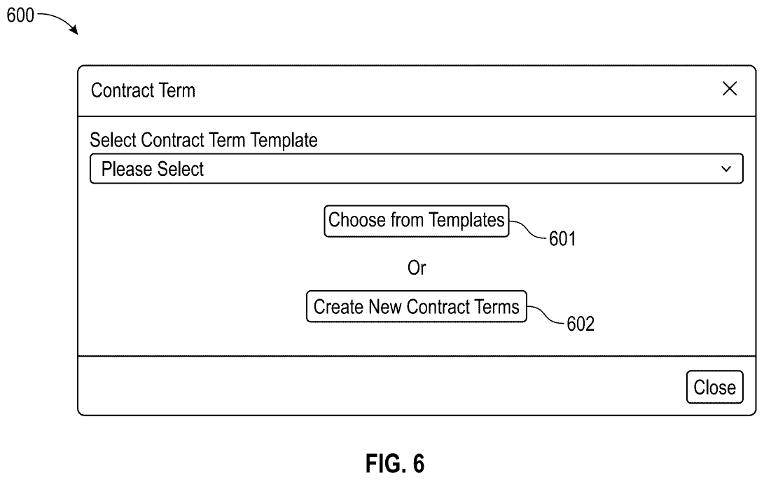

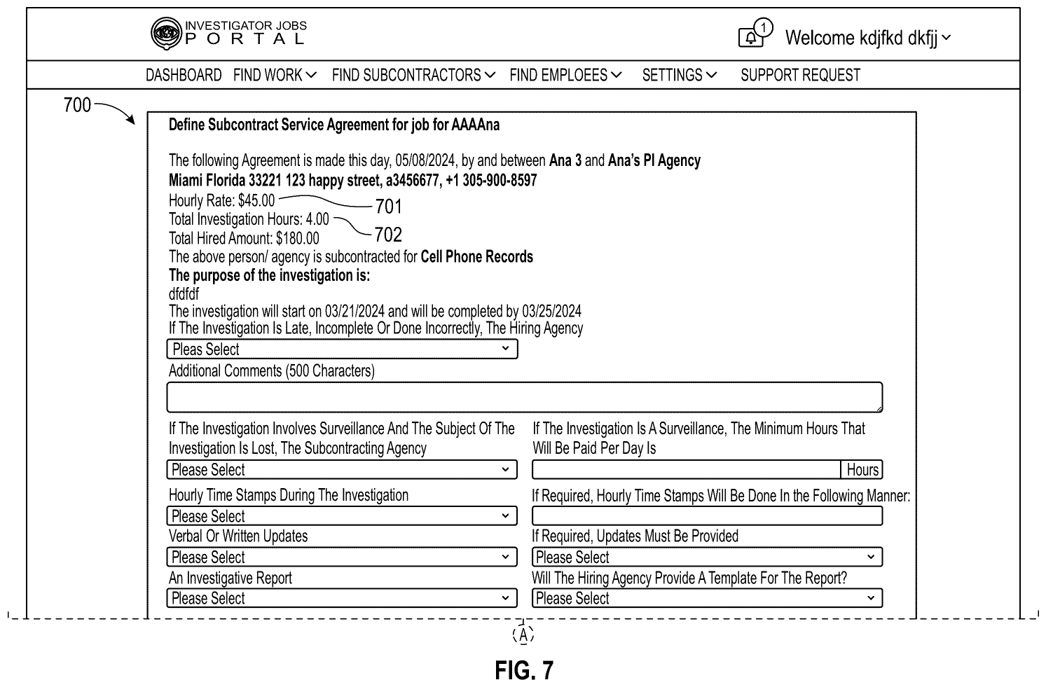

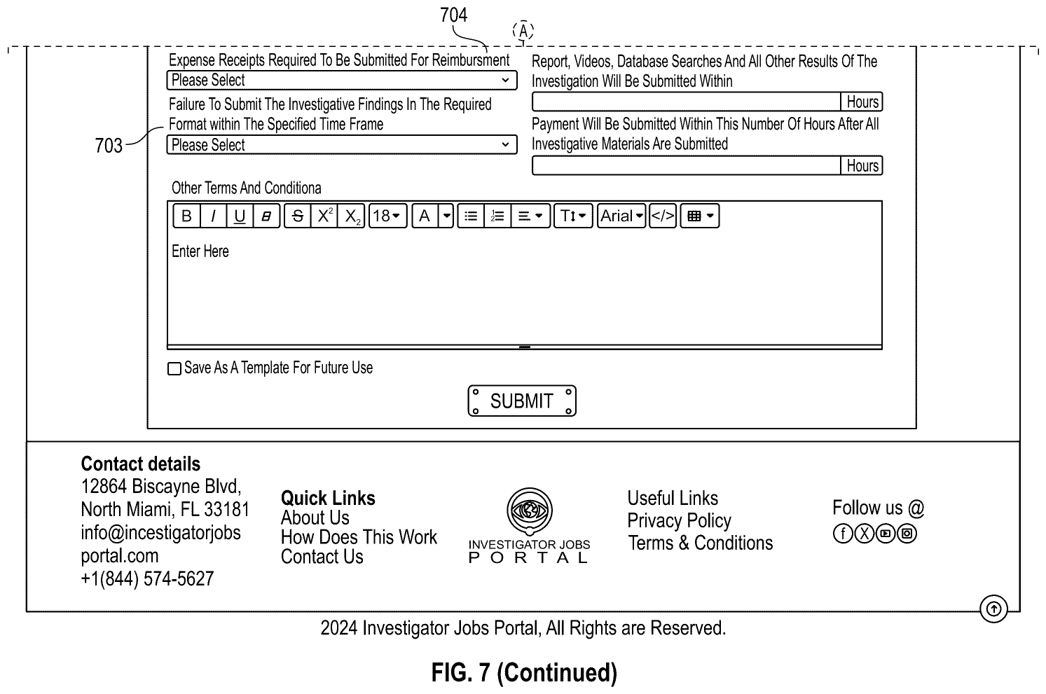

Further, in some embodiments, the platform presents role-specific workflow interfaces comprising features, tools, and communications configured to each user's operational needs. For private investigator agencies, the system 100 facilitates a workflow that includes searching for and inviting subcontractors for investigation jobs, hiring qualified subcontractors, and preparing service agreements either by creating new service agreements or selecting from existing templates as depicted FIG. 6. As shown in FIG. 6, the platform provides a user interface (UI) 600 for selecting 601 contract term templates from a database of templates or initiating 602 the creation of new contract terms. As illustrated in FIG. 7, the system 100 provides a detailed subcontract service agreement generation interface 700 where the hiring agency can define specific job parameters, terms, and expectations. This includes input fields for hourly rates 701, investigation duration 702, type of evidence required, reporting formats 703, update frequency, and reimbursement policies 704. The platform enables agencies to enforce standardized or customized investigative requirements, fostering clarity and accountability between the hiring and subcontracted parties before the commencement of an assignment.

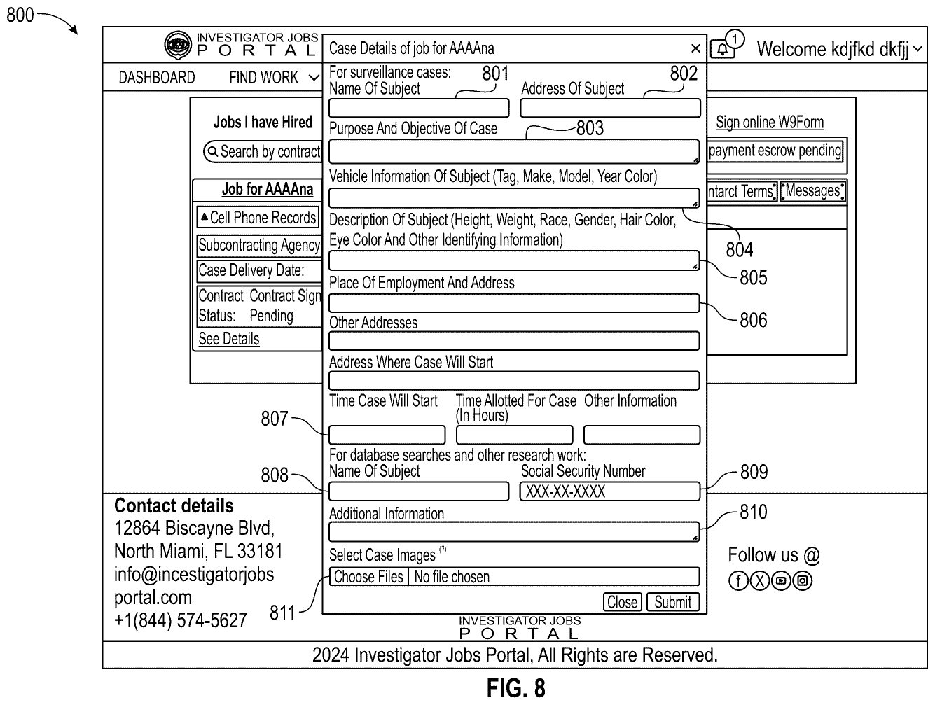

The workflow continues with service agreement execution, payment submission into the platform's escrow account, case information entry and document uploading, viewing of completed W9 forms, work review processes, dispute resolution when necessary, payment approval or withholding based on outcomes, and mutual rating systems for performance tracking. As depicted in FIG. 8, an example screenshot of a case information sheet 800 for a surveillance case is depicted. The hiring agency completes the case information sheet 800, providing all critical details needed by the subcontractor to carry out the investigation effectively. The details includes fields for the name of the subject 801, address 802, purpose and objective 803 of the case, vehicle details 804, subject's physical description 805, employment and associated addresses 806, and timing parameters 807. For surveillance assignments, the sheet 800 also accommodates case start times and duration. In some aspects, if any database search tasks are involved, the sheet 800 captures details like the subject's name 808, social security number 809, and other relevant data 810. Additionally, the interface allows for image and file uploads 811 to aid the subcontractor in preparation and execution of the task.

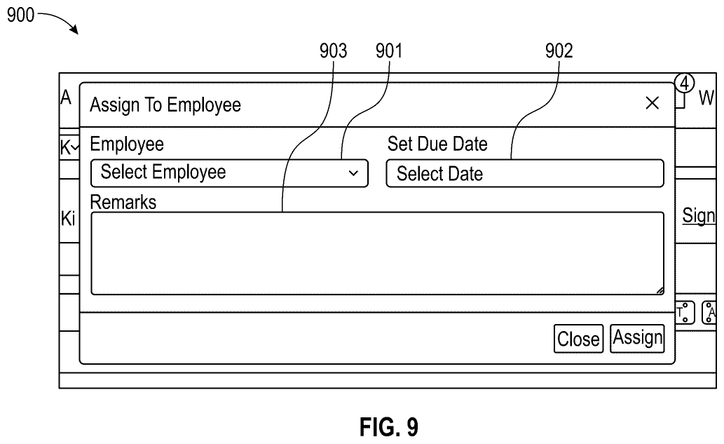

Upon hired for the job, as shown in FIG. 9, the subcontractor has the option to assign the investigation task to one of their registered employees through a user interface (UI) 900 that captures the employee's name 901, due date 902, and any specific remarks 903 related to the assignment. Once assigned, the designated employee receives access through a unique login ID. However, to maintain confidentiality and data integrity, the employee is not allowed to view full job details; instead, they are only granted access to the case documents necessary to perform their part of the investigation, thus enabling collaborative work while providing controlled information flow.

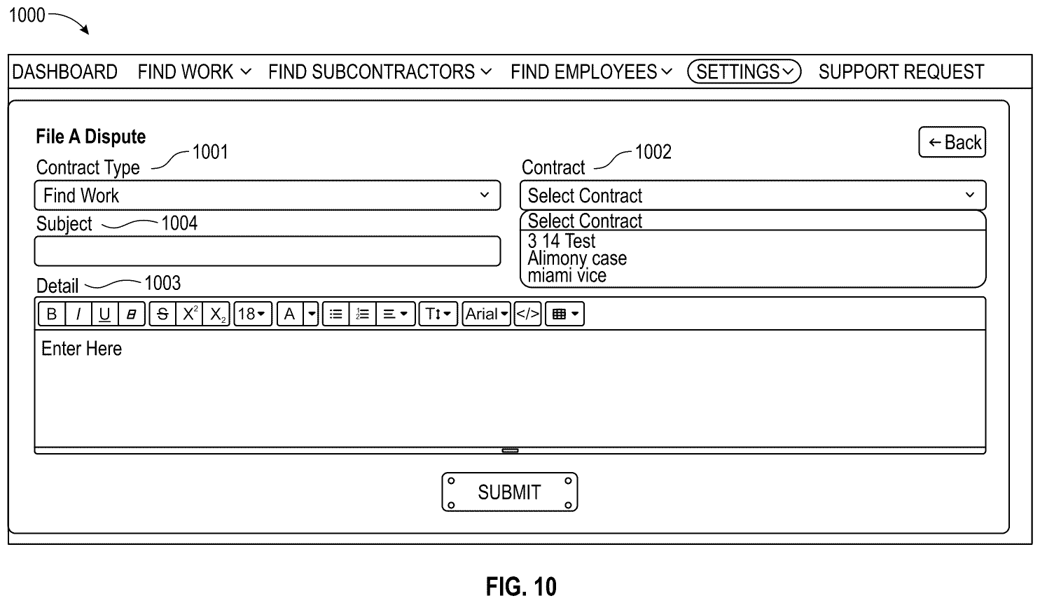

As illustrated in FIG. 10, if any disputes arise during the subcontracting process-whether due to payment delays, job performance issues, or other contractual disagreements-either party may initiate a dispute by navigating to the ‘Settings’ tab in the workflow interface and selecting, for example, the “File A Dispute” option. The interface 1000 shown in FIG. 10 allows users to specify the contract type 1001, select the relevant contract from a dropdown list 1002, and provide detailed information 1003 regarding a dispute subject 1004 and nature of the dispute. Once submitted, the dispute is routed to customer service for resolution and follow-up assistance. The dispute mechanism helps maintain professionalism and accountability on the platform.

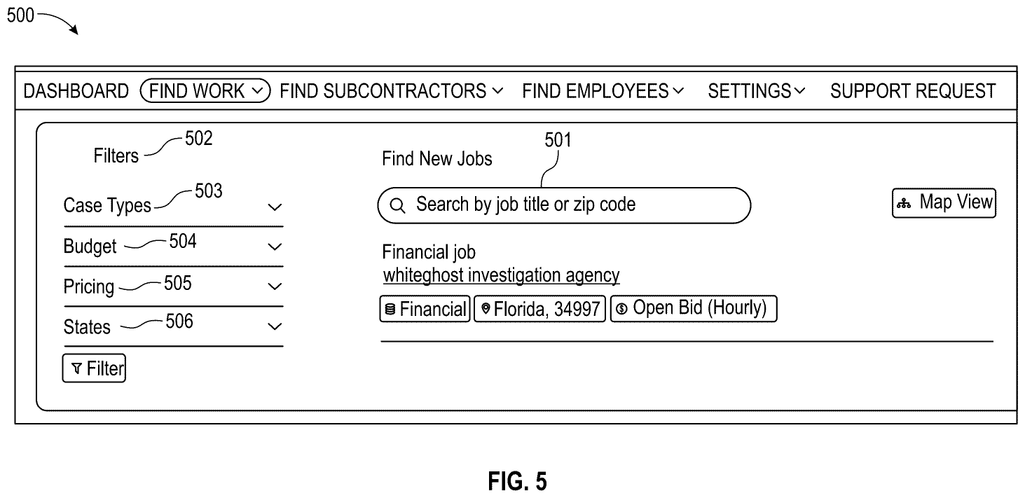

As depicted in FIG. 5, the job discovery interface 500 enables subcontractors to search 501 for open jobs using either list-based textual views or map-based geolocation views. The job discovery interface 500 supports filtering 502 based on various criteria including but not limited to case type 503, geographical area 506, budget range 504 and pricing 505 while allowing direct application submission from search results. The platform's search and filter capabilities provide additional filtering functionality that helps match appropriate investigators with specific case requirements based on location, specialization, and budget parameters.

According to an embodiment, a method 200 for facilitating subcontracting of investigation jobs is disclosed. The method is implemented using a system as discussed in preceding embodiments. The method initiates by the system providing 201 a web-based platform, wherein the web-based platform is configured to support three primary user roles: private investigator agencies, hiring-only agencies, and employees. These roles are associated with distinct workflows and access privileges managed through differentiated access levels. Upon accessing the platform, users undergo a secure authentication process 202 requiring identity verification and submission of appropriate licensing credentials. Once authenticated, users are presented 203 with a workflow interface that dynamically adapts to the authenticated role, providing a role-specific workflow environment equipped with tools, modules, and communication features.

In some embodiments, for private investigator agencies, the workflow interface enables two primary modes of operation-issuing referrals and subcontracting investigation jobs. In the referral mode, the platform provides a referral posting module that allows 204 a referring investigator to generate one or more non-subcontracted direct referrals for specific cases. Further, the referral posting module facilitates the inclusion of client contact information that becomes accessible to selected direct referrals upon their acceptance of the case. Referrals may, at their discretion, provide a monetary tip to the referring investigator. Further, in some aspects, the referring investigator is allowed to send reminders regarding such tips through an in-platform interface that supports direct messaging and notification-based prompts. Additionally, the referral posting module permits the referring investigator to block one or more specific members from viewing a referral posting, while allowing users to avoid sharing opportunities with individuals they prefer not to work with again.

In subcontracting mode, the private investigator agencies include a plurality of coordinated tasks. Initially, the private investigator agencies search for or directly invite subcontractors-including other private investigator agencies or platform-registered employees—to apply for specific investigation jobs. Upon selecting a subcontractor, the agency can initiate the preparation of a Service agreement through as a new document or by selecting from a plurality of customizable service agreement templates in the web-based platform. Once both parties, i.e. agencies and subcontractors, agree to the service agreement terms, the contract is digitally executed on the platform. The hiring private investigator agency then deposits the agreed payment into a secure escrow account managed by the platform, ensuring fair financial handling for both parties.

Further stages of the workflow allow the private investigator agency to upload and manage job details, including case descriptions, evidentiary documents, deadlines, and client information. A built-in document management system supports version control, access logs, and permissions. Subcontractors submit completed work through the platform, which is then reviewed by the hiring private investigator agency. In some aspects, when there is a job-related dispute upon submitting the work, the platform provides a dispute resolution interface wherein parties can initiate or respond to disputes, submit supporting evidence, and engage in moderated discussions. Payment is either approved or withheld depending on the resolution outcome. Finally, the private investigator agency and the subcontractor are prompted to rate each other based on quality of work, timeliness, and communication.

In an exemplary embodiment, the hiring-only agencies interact with a similar and slightly limited workflow interface. In this embodiment, these users are said to be not licensed to conduct investigations themselves and rely entirely on subcontracting. The workflow interface allows the hiring-only agencies to post investigation job listings either as private invitations to selected subcontractors or public posts visible to all eligible users on the platform. These listings may be defined with either a fixed fee or open-bid pricing model and must be accompanied by scope-of-work documents, deliverables, and deadline parameters.

In certain aspect, the hiring-only agency then engages, via the workflow interface, in a workflow largely analogous to the hiring-only agencies agency process: selecting subcontractors, executing service agreements, making escrow payments, uploading job-specific data, reviewing deliverables, resolving disputes, and issuing subcontractor ratings. These agencies also have access to completed W9 forms submitted by subcontractors, which are organized through an appropriate documentation module.

In accordance with some embodiments, employees-licensed investigators working independently or under a private investigator agency—have access to a workflow interface focused on task execution. Upon receiving job invitations from hiring entities, employees can view assigned jobs in a personalized dashboard. The interface allows access to all job-related documentation and facilitates timely submission of completed work. Employees can also participate in dispute resolution proceedings and are eligible to receive payment upon dispute clearance or job approval. After each completed engagement, the employee and hiring entity submit ratings, fostering reciprocal transparency and accountability.

In one example, the private investigator agencies who receive subcontracting opportunities themselves can apply for jobs posted by other hiring entities. Once hired, they may assign internal team members to handle the investigation, thus functioning in a dual capacity as both contractors and team managers. The flexible role-switching capability allows agencies to expand their operational bandwidth.

According to some embodiments, each user role is provided with a personalized dashboard that includes a profile section displaying credentials, licensing, and ratings. A job overview section categorizes engagements as active, completed, or pending, and an activity summary aggregates platform usage data including average ratings, number of disputes, and total earnings. These insights are visually represented through graphs and charts for intuitive interpretation. In some aspects, the platform also includes a notification management interface where users can configure alert preferences. These preferences include notification delivery methods—email, SMS, or in-platform pop-ups—as well as job-specific triggers such as new invitations, approaching deadlines, service agreement executions, work approvals, or dispute developments.

In some embodiments, subcontractors are further empowered by a job discovery interface. The job discovery interface allows browsing of open positions using both textual and map-based geolocation views. Jobs can be filtered by case type, budget, and location. Applications can be submitted directly from this interface, and subcontractors can propose their own timelines, payment rates, and travel costs. Optional application elements include uploading work samples and reviewing pre-set contract terms, with built-in options to request changes before confirming acceptance.

The platform's dynamic subcontract agreement module is pre-loaded with legally vetted templates configured to investigative services. It supports in-platform contract editing, allowing subcontractors to propose modifications and hiring entities to accept or revise terms before mutual digital signing. To enhance transparency and evidence chain-of-custody, the platform enables document uploads with optional geolocation tagging. When enabled, the GPS location at the time of upload is embedded as metadata, which can be useful for time-sensitive or location-verified evidence.

Together, these elements form an integrated and adaptive ecosystem for managing the subcontracting of investigation jobs. The platform supports end-to-end lifecycle management—from job posting and contractor discovery to service agreement execution, work delivery, dispute handling, payment release, and performance feedback—while ensuring legal compliance, user accountability, and operational efficiency across different user roles. The method transforms a traditionally fragmented subcontracting workflow into a centralized, secure, and user-friendly digital environment.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A method for facilitating subcontracting of investigation jobs, comprising:
providing a web-based platform with a plurality of differentiated access levels for at least three user roles including private investigator agencies, hiring-only agencies, and employees;
authenticating users through an application process requiring proof of identity and appropriate licensing;
upon successful authentication and login, presenting a workflow interface configured to the authenticated user's role, wherein the workflow interface includes access to features, tools, and communications specific to the authenticated user role; and
allowing the private investigator agencies to access a referral posting module that is configured to:
create one or more non-subcontracted direct referrals for specific cases by a referring investigator of the private investigator agency;
enable provision of client contact information to selected direct referrals upon acceptance;
allow direct referrals to optionally provide a tip to the referring investigator upon case acceptance; and
allow the referring investigator to send tipping reminders through an in-platform interface.

2. The method of claim 1, wherein the workflow interface presented to the private investigator agency facilitates a workflow comprising:
searching for and inviting one or more subcontractors for an investigation job;
hiring at least one subcontractor;
preparing a service agreement for the job by creating a new service agreement or selecting an existing service agreement template;
executing the service agreement with the hired subcontractor;
submitting payment, corresponding to the job, into an escrow account maintained by the platform;
entering case information into job details and uploading related documentation;
viewing completed W9 forms submitted by subcontractors;
reviewing work submitted by the subcontractor;
initiating or responding to a dispute resolution process if applicable;
approving or withholding payment based on the dispute outcome; and
submitting ratings for the hired subcontractor.

3. The method of claim 1, wherein the workflow interface presented to a hiring-only agency facilitates a workflow comprises:
posting investigation job opportunities or inviting one or more subcontractors to the investigation job opportunities, wherein subcontractors include at least one of private investigator agencies and employees;
hiring at least one subcontractor;
preparing a service agreement for the job by creating a new service agreement or selecting an existing service agreement template;
executing the service agreement with the hired subcontractor;
submitting payment, corresponding to the job, into an escrow account maintained by the platform;
entering case information into job details and uploading related documentation;
viewing completed W9 forms submitted by subcontractors;
reviewing work submitted by the subcontractor;
initiating or responding to a dispute resolution process if applicable;
approving or withholding payment based on the dispute outcome; and
submitting ratings for the hired subcontractor.

4. The method of claim 1, wherein the workflow interface presented to an employee facilitates a workflow comprising:
allowing the employee to accept a job invitation received from an employer, the employer being the private investigator agency or hiring-only agency;
viewing one or more assigned jobs;
accessing job information and associated documents;
submitting completed work for the assigned job;
initiating or responding to a dispute resolution process if applicable;
receiving payment if no dispute arises or once the dispute is resolved; and
allowing the employee to rate the employer upon job completion.

5. The method of claim 1, wherein the workflow interface for a private investigator agency facilitates another workflow comprising:
searching for investigation job postings;
submitting applications to one or more available jobs;
receiving a hiring confirmation for a selected job;
executing the service agreement with the hired employer;
accessing job information and associated documents;
optionally assigning one or more internal employees to the job;
submitting completed work for the assigned job;
initiating or responding to a dispute resolution process if applicable;
receiving payment if no dispute arises or once the dispute is resolved; and
allowing to rate the employer upon job completion.

6. The method of claim 1, wherein the workflow interface for each user role further comprises access to a personalized dashboard displaying:
a user profile section including licensing and credential details;
a job overview section listing active, past, and pending job engagements, and
a summary section aggregating activity metrics such as number of completed jobs, average rating, open disputes, and earnings.

7. The method of claim 1, further comprising a notification management interface that enables users to:
configure notification preferences for receiving job-related alerts via email, SMS, or in-platform notifications; and
select the types of jobs or updates for which alerts should be generated, including invitations, deadlines, approvals, or disputes.

8. The method of claim 1, wherein the platform provides a job discovery interface for subcontractors that enables:
searching for open jobs posted by hiring entities using either a list-based textual view or a map-based geolocation view,
filtering jobs by case type, geographical area, and budget range, and
submitting job applications directly from the search results interface.

9. The method of claim 1, wherein the job posting interface for hiring-only agencies allows:
configuring a job to be visible only to selected subcontractors as private invitations or to all platform users as public listings;
defining the job's payment model as either a fixed budget or an open-bid format; and
attaching scope-of-work documentation and required deliverables to the post.

10. The method of claim 1, wherein the web-based platform includes an application interface for subcontractors that enables:
proposing start and end dates for the case;
stating a proposed payment amount and travel fee;
attaching work samples as part of the application; and
reviewing default contract terms with the ability to agree or request edits before job confirmation.

11. The method of claim 1, wherein the web-based platform includes a dynamic subcontract agreement module that:
includes industry-specific legal templates configured to private investigation services;
allows subcontractors to initiate edit requests to contract terms via in-platform messaging; and
enables hiring entities to modify the contract based on feedback and resend it for digital acceptance.

12. The method of claim 1, wherein uploaded job-related documents are:
viewable by the hiring-only agency via a centralized interface, and
associated with geolocation metadata identifying the GPS location of upload, if the subcontractor has opted into location monitoring.

13. The method of claim 1, further comprising:
enabling a user posting a job or referral to designate one or more specific members to be blocked; and
preventing the designated blocked members from viewing the corresponding job posting or referral.

14. A web-based platform for facilitating subcontracting of investigation jobs, comprising:
a plurality of differentiated access levels configured for at least three user roles, including private investigator agencies, hiring-only agencies, and employees;
an authentication module configured to verify users through an application process requiring proof of identity and applicable licensing;
a workflow interface generator configured to present, upon successful authentication and login, a role-specific workflow interface comprising features, tools, and communications configured to the authenticated user's role;
a referral posting module accessible to private investigator agencies, wherein the referral posting module is configured to:
allow a referring investigator of the private investigator agency to create one or more non-subcontracted direct referrals for specific cases;
enable provision of client contact information to selected direct referrals upon acceptance;
allow direct referrals to optionally provide a tip to the referring investigator upon case acceptance; and
allow the referring investigator to send tipping reminders through an in-platform interface.

15. The web-based platform of claim 14, wherein the workflow interface presented to the private investigator agency facilitates a workflow comprising:
searching for and inviting one or more subcontractors for an investigation job;
hiring at least one subcontractor;
preparing a service agreement for the job by creating a new service agreement or selecting an existing service agreement template;
executing the service agreement with the hired subcontractor;
submitting payment, corresponding to the job, into an escrow account maintained by the platform;
entering case information into job details and uploading related documentation;
viewing completed W9 forms submitted by subcontractors;
reviewing work submitted by the subcontractor;
initiating or responding to a dispute resolution process if applicable;
approving or withholding payment based on the dispute outcome; and
submitting ratings for the hired subcontractor.

16. The web-based platform of claim 14, wherein the workflow interface presented to a hiring-only agency facilitates a workflow comprises:
posting investigation job opportunities or inviting one or more subcontractors to the investigation job opportunities, wherein subcontractors include at least one of private investigator agencies and employees;
hiring at least one subcontractor;
preparing a service agreement for the job by creating a new service agreement or selecting an existing service agreement template;
executing the service agreement with the hired subcontractor;
submitting payment, corresponding to the job, into an escrow account maintained by the platform;
entering case information into job details and uploading related documentation;
viewing completed W9 forms submitted by subcontractors;
reviewing work submitted by the subcontractor;
initiating or responding to a dispute resolution process if applicable;
approving or withholding payment based on the dispute outcome; and
submitting ratings for the hired subcontractor.

17. The web-based platform of claim 14, wherein the workflow interface presented to an employee facilitates a workflow comprising:
allowing the employee to accept a job invitation received from an employer, the employer being the private investigator agency or hiring-only agency;
viewing one or more assigned jobs;
accessing job information and associated documents;
submitting completed work for the assigned job;
initiating or responding to a dispute resolution process if applicable;
receiving payment if no dispute arises or once the dispute is resolved; and
allowing the employee to rate the employer upon job completion.

18. The web-based platform of claim 14, wherein the workflow interface for a private investigator agency facilitates another workflow comprising:
searching for investigation job postings;
submitting applications to one or more available jobs;
receiving a hiring confirmation for a selected job;
executing the service agreement with the hired employer;
accessing job information and associated documents;
optionally assigning one or more internal employees to the job;
submitting completed work for the assigned job;
initiating or responding to a dispute resolution process if applicable;
receiving payment if no dispute arises or once the dispute is resolved; and
allowing to rate the employer upon job completion.

19. The web-based platform of claim 14, wherein the workflow interface for each user role further comprises access to a personalized dashboard displaying:
a user profile section including licensing and credential details;
a job overview section listing active, past, and pending job engagements, and
a summary section aggregating activity metrics such as number of completed jobs, average rating, open disputes, and earnings.

20. The web-based platform of claim 14, further comprising a notification management interface that enables users to:
configure notification preferences for receiving job-related alerts via email, SMS, or in-platform notifications; and
select the types of jobs or updates for which alerts should be generated, including invitations, deadlines, approvals, or disputes.

21. The web-based platform of claim 14, wherein the platform provides a job discovery interface for subcontractors that enables:
searching for open jobs posted by hiring entities using either a list-based textual view or a map-based geolocation view,
filtering jobs by case type, geographical area, and budget range, and
submitting job applications directly from the search results interface.

22. The web-based platform of claim 14, wherein the job posting interface for hiring-only agencies allows:
configuring a job to be visible only to selected subcontractors as private invitations or to all platform users as public listings;
defining the job's payment model as either a fixed budget or an open-bid format; and
attaching scope-of-work documentation and required deliverables to the post.

23. The web-based platform of claim 14 further includes an application interface for subcontractors that enables:
proposing start and end dates for the case;
stating a proposed payment amount and travel fee;
attaching work samples as part of the application; and
reviewing default contract terms with the ability to agree or request edits before job confirmation.

24. The web-based platform of claim 14 further includes a dynamic subcontract agreement module that:
includes industry-specific legal templates configured to private investigation services;
allows subcontractors to initiate edit requests to contract terms via in-platform messaging; and
enables hiring entities to modify the contract based on feedback and resend it for digital acceptance.

25. The web-based platform of claim 14, wherein uploaded job-related documents are:
viewable by the hiring-only agency via a centralized interface, and
associated with geolocation metadata identifying the GPS location of upload, if the subcontractor has opted into location monitoring.

26. The web-based platform of claim 14 further comprising:
enabling a user posting a job or referral to designate one or more specific members to be blocked; and
preventing the designated blocked members from viewing the corresponding job posting or referral.
